(19) United States
(12) Patent Application Publication
(10) Pub. No.: US 2024/0371571 A1
(43) Pub. Date: Nov. 7, 2024

(54) MULTILAYER CERAMIC CAPACITOR

(71) Applicant: Murata Manufacturing Co., Ltd., Nagaokakyo-shi (JP)

(72) Inventor: Hayato FUKUSHIMA, Nagaokakyo-shi (JP)

(21) Appl. No.: 18/773,744

(22) Filed: Jul. 16, 2024

Related U.S. Application Data
(63) Continuation of application No. PCT/JP2023/031211, filed on Aug. 29, 2023.

(30) Foreign Application Priority Data
Nov. 4, 2022 (JP) 2022-177404

(51) Int. Cl. H01G 4/12; H01G 4/012; H01G 4/30

(52) U.S. Cl. CPC H01G 4/1227; H01G 4/012; H01G 4/30

(57) ABSTRACT

A multilayer ceramic capacitor includes a multilayer body and external electrodes. The multilayer body includes an internal layer portion, a first side margin portion and a second side margin portion on both sides of the internal layer portion in a width direction, and a pair of external layer portions on both sides of the internal layer portion in a lamination direction to be positioned between the side margin portions. The multilayer ceramic capacitor includes first and second cover regions including an inorganic material and located on outer surfaces of the multilayer body to each span boundaries between the first or second side margin portion and the external layer portions. End surfaces of the multilayer ceramic capacitor each include an uncovered section that is not covered by the cover region, and are each connected to the external electrode at the uncovered section.

### CROSS REFERENCE TO RELATED APPLICATIONS

This application claims the benefit of priority to Japanese Patent Application No. 2022-177404 filed on Nov. 4, 2022 and is a Continuation Application of PCT Application No. PCT/JP2023/031211 filed on Aug. 29, 2023. The entire contents of each application are hereby incorporated herein by reference.

### BACKGROUND OF THE INVENTION

### 1. Field of the Invention

The present invention relates to multilayer ceramic capacitors.

### 2. Description of the Related Art

In recent years, attempts have been made to reduce the size of multilayer ceramic electronic components, such as multilayer ceramic capacitors, and increase the capacitance thereof. In order to reduce the size of a multilayer ceramic capacitor and increase the capacitance thereof, it is effective to make side margins thin relative to the side surfaces of a multilayer body in which a plurality of dielectric ceramic layers and a plurality of internal electrode layers are stacked, thereby increasing the area of the internal electrode layers, which are opposed to each other.

For example, Japanese Unexamined Patent Application, Publication Nos. 2012-191159 and 2014-204116 each describe a technique in which a multilayer chip that has side surfaces on which internal electrodes are exposed has formed thereon, at a later time, side margin portions for ensuring the insulation property of the vicinity of the internal electrodes. In this way, the side margin portions can be made thin, and the intersecting area of the internal electrodes can be relatively large.

### SUMMARY OF THE INVENTION

With respect to each of the multilayer ceramic capacitors in Japanese Unexamined Patent Application, Publication Nos. 2012-191159 and 2014-204116, however, moisture may infiltrate into the multilayer body through the boundary between the multilayer body and side margins. Thus, there is concern that the moisture resistance reliability of the multilayer ceramic capacitor may decrease.

Example embodiments of the present invention provide multilayer ceramic capacitors each capable of having an enhanced moisture resistance reliability.

A multilayer ceramic capacitor according to an example embodiment of the present invention includes a multilayer body including an internal layer portion in which a plurality of dielectric layers and a plurality of internal electrode layers are stacked in an alternating pattern, one pair of main surfaces opposed to each other in a lamination direction, one pair of end surfaces opposed to each other in a lengthwise direction orthogonal to the lamination direction, and one pair of side surfaces opposed to each other in a width direction orthogonal to both the lamination direction and the lengthwise direction, and one pair of external electrodes located on the respective end surfaces and connected to the internal electrode layers, in which the multilayer body includes one pair of side margin portions on both sides of the internal layer portion in the width direction, and one pair of external layer portions on both sides of the internal layer portion in the lamination direction so as to be positioned between the side margin portions, the one pair of side surfaces includes a first side surface and a second side surface, the one pair of side margin portions includes a first side margin portion on the first side surface and a second side margin portion on the second side surface, the multilayer ceramic capacitor further includes a first cover region including an inorganic material and positioned on outer surfaces of the multilayer body so as to span boundaries between the first side margin portion and the respective external layer portions, and a second cover region including the inorganic material and positioned on outer surfaces of the multilayer body so as to span boundaries between the second side margin portion and the respective external layer portions, and the end surfaces each include an uncovered section not covered with either the first cover region or the second cover region, and connected to the external electrodes at the uncovered sections.

Example embodiments of the present invention each reduce or prevent infiltration of moisture into the multilayer ceramic capacitor through a boundary between each side margin portion and each external layer portion, so that the moisture resistance reliability of the multilayer ceramic capacitor is enhanced.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic capacitor.

FIG. 2 is a cross-sectional view of the multilayer ceramic capacitor taken along line II-II of FIG. 1.

FIG. 3 is a cross-sectional view of the multilayer ceramic capacitor taken along line III-III of FIG. 1.

FIG. 4 is a schematic perspective view of a multilayer body with cover regions provided thereon.

FIGS. 5A to 5C illustrate manufacturing steps for manufacturing the multilayer ceramic capacitor.

FIGS. 6A to 6C illustrate manufacturing steps for manufacturing the multilayer ceramic capacitor.

FIGS. 7A to 7C illustrate manufacturing steps for manufacturing the multilayer ceramic capacitor.

FIGS. 8A to 8C, which corresponds to FIG. 2, illustrate the configuration of a multilayer ceramic capacitor according to a modification of an example embodiment of the present invention.

### DETAILED DESCRIPTION OF THE EXAMPLE EMBODIMENTS

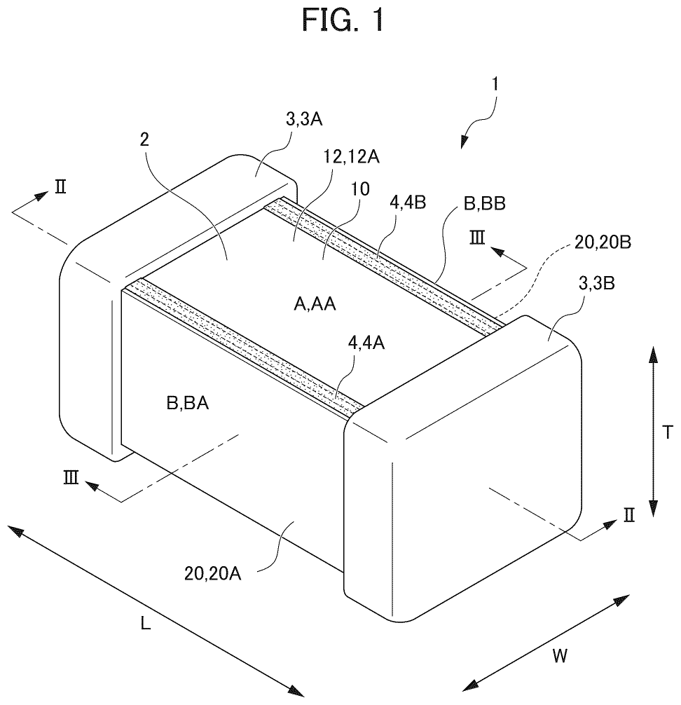

The following describes example embodiments of the present invention on the basis of FIGS. 1 to 4.

### Multilayer Ceramic Capacitor 1

As depicted in FIGS. 1 to 3, the multilayer ceramic capacitor 1 has a substantially cuboid shape and includes a multilayer body 2 and a pair of external electrodes 3 provided on two ends of the multilayer body 2.

With respect to terms representing orientations of the multilayer ceramic capacitor 1 in the following description, a lengthwise direction L is the direction in which the pair of external electrodes 3 are arranged for the multilayer ceramic capacitor 1. A lamination direction T is the direction in which dielectric layers 14 and internal electrode layers 15 are stacked. A width direction W intersects both the lengthwise direction L and the lamination direction T. In example embodiments, the width direction W is orthogonal to both the lengthwise direction L and the lamination direction T.

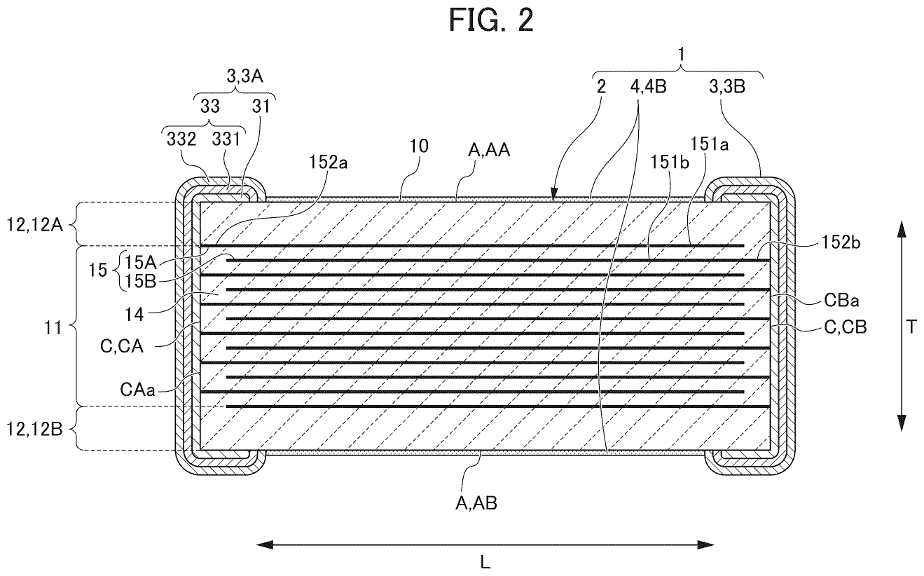

The following description is based on the assumption that, from among the six outer peripheral surfaces of the multilayer body 2 depicted in FIG. 1, a pair of outer surfaces opposite to each other in the lamination direction T are two main surfaces A, a pair of outer surfaces opposite to each other in the width direction W are two side surfaces B, and a pair of outer surfaces opposite to each other in the lengthwise direction L are two end surfaces C. One of the two main surfaces A is a first main surface AA, and the other is a second main surface AB (see FIG. 2). One of the two end surfaces C is a first end surface CA, and the other is a second end surface CB. When the first main surface AA and the second main surface AB do not particularly need to be distinguished from each other for description, both are referred to as main surfaces A. When the first end surface CA and the second end surface CB do not particularly need to be distinguished from each other for description, both are referred to as end surfaces C.

### Multilayer Body 2

The multilayer body 2 includes a multilayer body chip 10 and side margin portions 20. The multilayer body 2 has a cuboid shape. A corner and a ridge line portion of the multilayer body 2 are preferably rounded. The corner is a portion of the multilayer body at which three surfaces thereof meet. The ridge line portion is a portion of the multilayer body at which two surfaces thereof meet.

### Multilayer Body Chip 10

The multilayer body chip 10 includes an internal layer portion 11 and external layer portions 12 disposed on the two main-surface-A sides of the internal layer portion 11. From among the external layer portions 12, the one disposed on the first-main-surface-AA side is referred to as a first external layer portion 12A, and the one disposed on the second-main-surface-AB side is referred to as a second external layer portion 12B. When the first external layer portion 12A and the second external layer portion 12B do not particularly need to be distinguished from each other, both are hereinafter referred to as “external layer portions 12.”

### Internal Layer Portion 11

The internal layer portion 11 is formed by stacking a plurality of dielectric layers 14 and a plurality of internal electrode layers 15.

### Dielectric Layers 14

The dielectric layers 14 include a ceramic material, in particular, a dielectric ceramic material. The dielectric layers 14 include ceramic particles. The ceramic particles, which are particles (main crystal particles) that are a main component for the dielectric layers 14, are formed from a compound that has a perovskite-type structure including Ba and/or Ti. In particular, the dielectric layers 14 are sintered polycrystal bodies including, as a main component, a compound that has a perovskite-type structure.

The dielectric layers 14 may include another component other than the main component as an additive. For example, the additive is at least one of Si, Mg, Ba, or Mn. In the dielectric layers 14, for example, the additive is present between the ceramic particles.

The thickness of the dielectric layers 14 is preferably about 0.2 μm or greater and not greater than about 0.8 μm, more preferably, about 0.2 μm or greater and not greater than about 0.55 μm, for example. In this way, the number of layers to be stacked can be increased even with the size of the multilayer body 2 remaining the same, thereby ensuring electrostatic capacitance.

### Internal Electrode Layers 15

The internal electrode layers 15 include a plurality of first internal electrode layers 15A and a plurality of second internal electrode layers 15B. The first internal electrode layers 15A and the second internal electrode layers 15B are arranged in an alternating pattern. When the first internal electrode layers 15A and the second internal electrode layers 15B do not particularly need to be distinguished from each other for description, all of these layers are referred to as internal electrode layers 15.

The internal electrode layers 15 are preferably formed from a metal material typified by, for example, Ni, Cu, Ag, Pd, an Ag—Pd alloy, or Au.

The first internal electrode layers 15A include first opposed sections 151a opposed to the second internal electrode layers 15B, and first lead-out sections 152a led out from the first opposed sections 151a toward the first end surface CA. End portions of the first lead-out sections 152a are exposed on the first end surface CA and electrically connected to a first external electrode 3A, which is described hereinafter.

The second internal electrode layers 15B include second opposed sections 151b opposed to the first internal electrode layers 15A, and second lead-out sections 152b led out from the second opposed sections 151b toward the second end surface CB. End portions of the second lead-out sections 152b are electrically connected to a second external electrode 3B, which is described hereinafter.

The internal electrode layers 15 produce a capacitor characteristics as a result of charge being stored in the first opposed sections 152a of the first internal electrode layers 15A and the second opposed sections 152b of the second internal electrode layers 15B.

The edge portions of the internal electrode layers 15 on the first-side-surface-BA side are even with the surface of the internal layer portion 11 on the first-side-surface BA side. All of the edge portions of the internal electrode layers 15 on the second-side-surface-BB side are even with the surface of the internal layer portion 11 on the second-side-surface-BB side.

The thickness of each of the internal electrode layers 15 is preferably about 0.2 μm or greater and not greater than about 2.0 μm, more preferably, about 0.2 μm or greater and not greater than about 0.5 μm, for example. In this way, the number of layers to be stacked can be increased even with the size of the multilayer body 2 remaining the same, thereby ensuring electrostatic capacitance. The number of internal electrode layers 15 is preferably 15 or greater and not greater than 1000, for example.

### External Layer Portions 12

The external layer portions 12 can be manufactured from a dielectric ceramic material. The external layer portions 12 may be manufactured from the same dielectric ceramic material as the dielectric layers 14 of the internal layer portion 11, or may be manufactured from a different dielectric ceramic material from the dielectric layers 14 of the internal layer portion 11. The thickness of each of the external layer portions 12 is about 15 μm or greater and not greater than about 60 μm, for example.

The external layer portions 12 may each have a multilayer structure. When the external layer portions 12 include Si, the external layer portions 12 may include segregated portions of Si. In these cases, layers that are positioned to be spaced farther from the internal layer portion 11, from among the plurality of layers forming one external layer portion 12, preferably include more segregated portions of Si than the layer that is the closest to the internal layer portion 11. In this way, the bending strength of the multilayer ceramic capacitor 1 in the lamination direction T can be enhanced.

For example, the total number of dielectric layers 14, internal electrode layers 15, and external layer portions 12 (i.e., the number of stacked layers of the multilayer body 2) is preferably 15 or greater and not greater than 1000, for example.

### Side Margin Portions 20

The side margin portions 20 can be manufactured from a dielectric ceramic material. The side margin portions 20 may be manufactured from the same dielectric ceramic material as the dielectric layers 14 of the internal layer portion 11, or may be manufactured from a different dielectric ceramic material from the dielectric layers 14 of the internal layer portion 11. The side margin portions 20 are respectively provided on the two side-surface-B sides of the portion in which the internal layer portion 11 and the external layer portions 12 are stacked. The external layer portions 12 are positioned between the side margin portions 20 in the width direction W. The edge portions, on the width-direction-W side, of the internal electrode layers 15 that are exposed on the two side surfaces of the multilayer body chip 10 are covered with the side margin portions 20 along these edge portions.

From among the side margin portions 20, the one disposed on the first-side-surface-BA side is referred to as a first side margin portion 20A, and the one disposed on the second-side-surface-BB side is referred to as a second side margin portion 20B. When the first side margin portion 20A and the second side margin portion 20B do not particularly need to be distinguished from each other, both may be referred to as “side margin portions 20.”

The dimension of the first side margin portion 20A in the width direction W is preferably about 5 μm or greater and not greater than about 40 μm, more preferably, about 5 μm or greater and not greater than about 20 μm, for example. The dimension of the second side margin portion 20B in the width direction W is preferably about 5 μm or greater and not greater than about 40 μm, more preferably, about 5 μm or greater and not greater than about 20 μm, for example. In this way, the capacitance of the multilayer ceramic capacitor 1 can be increased while ensuring the moisture resistance reliability of the multilayer ceramic capacitor 1.

A method for measuring the dimensions of the first side margin portion 20A and the second side margin portion 20B in the width direction W may involve observing, with a scanning electron microscope, a WT cross section of the multilayer body 2 that has been exposed by, for example, polishing. Each value is obtained by averaging measurement values at a plurality of sites in the lamination direction T.

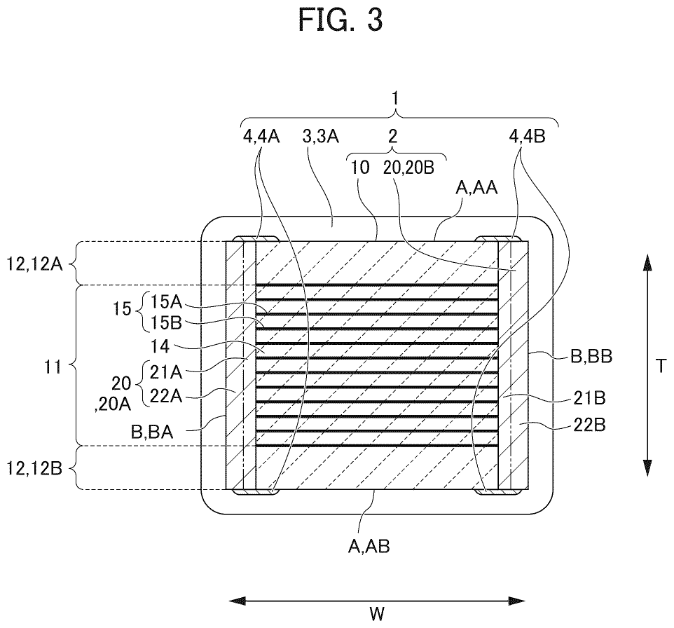

The first side margin portion 20A includes a plurality of layers, in particular, two layers (see FIG. 3). The first side margin portion 20A includes two layers, one of which is a first inner layer 21A disposed closer to the internal layer portion 11 than the other is, and the other is a first outer layer 22A disposed farther from the internal layer portion 11 than the first inner layer 21A is.

The second side margin portion 20B includes a plurality of layers, in particular, two layers. The second side margin portion 20B includes two layers, one of which is a second inner layer 21B disposed closer to the internal layer portion 11 than the other is, and the other is a second outer layer 22B disposed farther from the internal layer portion 11 than the second inner layer 21B is.

When the first inner layer 21A and the second inner layer 21B do not particularly need to be distinguished from each other, both may hereinafter be referred to as “inner layers 21.”

When the first outer layer 22A and the second outer layer 22B do not particularly need to be distinguished from each other, both may be referred to as “outer layers 22.”

The side margin portions 20 are not limited to a two-layer structure, but may have a single-layer structure or may include three or more layers. When the side margin portions 20 each include three or more layers, the layer that is disposed so as to be the closest to the internal layer portion 11 among the plurality of layers of the side margin portion 20 is referred to as an inner layer, and the layer that is disposed so as to be the farthest from the inner layer 11 among the plurality of layers is referred to as an outer layer. Meanwhile, the first side margin portion 20A and the second side margin portion 20B may each have a different number of layers.

When the side margin portion 20 has a two-layer structure, including an inner layer and an outer layer, it can be checked, owing to the difference in sinterability between the inner layer and the outer layer, that the side margin portion 20 has a two-layer structure by performing observation with an optical microscope under dark-field condition, and the interface between the layers can also be checked by doing so. This is also true when the side margin portion 20 has three or more layers. Note that the inner layer and the outer layer after sintering may not be recognized as defining a two-layer structure. Even when the layers cannot be recognized as defining a two-layer structure, the layers may be distinguished from each other as two regions on the basis of the difference in the type of elements or the content of elements.

### Ceramic Grains

The dielectric layers 14, the external layer portions 12, and the side margin portions 20 may include ceramic grains. In this case, interface resistance is generated at the interface between the ceramic grains, so that the internal electrode layers 15 can have increased insulation resistance against each other. Hence, the occurrence of shorting in the multilayer ceramic capacitor 1 can be reduced or prevented.

A rare-earth element is preferably present at the interface between the ceramic grains. The presence of a rare-earth element at the interface between the ceramic grains can be checked through a TEM-EDX elemental analysis. The rare-earth element may be, for example, La, Ce, Pr, Nd, Sm, Eu, Gd, Tb, Dy, Ho, Er, Tm, Yb, Lu, or Y. With the presence of a rare-earth element at the interface between the ceramic grains, the interface resistance of the dielectric ceramic layers can be further increased. Thus, the reliability of the multilayer ceramic capacitor can be further enhanced. Note that Mg, Mn, Si, etc. may also be present.

With reference to 100 moles of Ti, about 0.2 mol % or greater and not greater than about 5 mol % of rare-earth element is preferably present, for example. The 100 moles of Ti in this example defines the abundance of the rare-earth element with reference to 100 moles of Ti on the assumption that the dielectric ceramic material forming the dielectric ceramic layers includes a compound having a perovskite-type structure (structure indicated by ABO₃, where B=Ti) as a main component. The abundance of the rare-earth element can be identified using a TEM-EDX technique.

### Composition of Multilayer Body 2

When the dielectric layers 14, the external layer portions 12, and the side margin portions 20 include a dielectric ceramic, the composition of at least one dielectric ceramic layer from among the dielectric ceramic layers defining the dielectric layers 14, the dielectric ceramic layers defining the external layer portions 12, the dielectric ceramic layers defining the side margin portions 20 may be different from the composition of the other dielectric ceramic layers.

The dielectric layers 14, the external layer portions 12, and the side margin portions 20 are each required to have different characteristics in terms of the purpose of disposing the same and the manufacturing method. Thus, the composition of at least one dielectric ceramic layer from among the dielectric ceramic layers forming the dielectric layers 14, the external layer portions 12, and the side margin portions 20 can be made different from the composition of the others, thereby achieving optimum compositions corresponding to the locations at which the dielectric layers 14, the external layer portions 12, and the side margin portions 20 are disposed. Thus, the reliability of the multilayer ceramic capacitor 1 can be enhanced.

When the side margin portions 20 each include a plurality of dielectric ceramic layers, the plurality of dielectric ceramic layers forming the side margin portion 20 may have the same composition or may each have a different composition.

When the composition of one of the plurality of dielectric ceramic layers defining the side margin portion 20 is different from the dielectric layers 14, it can be said that the composition of the side margin portion 20 is different from the composition of the dielectric layers 14. When the composition of one of the plurality of dielectric ceramic layers forming the side margin portion 20 is different from the external layer portions 12, it can be said that the composition of the side margin portion 20 is different from the composition of the external layer portions 12.

From among the dielectric ceramic layers defining the dielectric layers 14, the dielectric ceramic layers defining the external layer portions 12, the dielectric ceramic layers defining the side margin portions 20, a dielectric ceramic layer having a different composition from the other dielectric ceramic layers preferably includes the same main component as the other dielectric ceramic layers and a different type of additive from the other dielectric ceramic layers. The main component may be, for example, BaTiO₃, CaTiO₃, or SrTiO₃. Elements of the additive are preferably Si, Mg, Mn, Sn, Cu, a rare-earth element, Ni, and Al. The dielectric ceramic layers defining the dielectric layers 14, the dielectric ceramic layers defining the external layer portions 12, and the dielectric ceramic layers defining the side margin portions 20 may include two or more types from among the abovementioned elements of the additive.

The wording “have the same composition” means that: the same type of element is included in the dielectric ceramics forming the dielectric ceramic layers, and the content rates (mole ratios) of the other elements are all within about ±0.5% with reference to Ti, for example. Assume that the difference between the diameters of the ceramic grains defining the dielectric ceramic layers or the difference in a void between the dielectric ceramic layers does not constitute a difference in composition between the dielectric ceramic layers.

The composition of each of the dielectric ceramic layers can be determined through a process in which a cut section on which the dielectric ceramic layer is exposed as a result of cutting the multilayer ceramic capacitor 1 is subjected to an elemental analysis based on wavelength dispersive X-ray spectroscopy (WDX) or transmission electron microscopy linked with energy-dispersive X-ray spectroscopy (TEM-EDX). In this case, the composition of each of the dielectric ceramic layers is measured at five sites, and then the average value is determined.

When the side margin portion 20 has a multi-layered structure, the composition of each of the layers is measured at five sites, the obtained compositions are multiplied by the percentage of the thickness (i.e., dimension in the width direction W) of each of the layers with reference to the side margin portion 20, and the total sum of the results of multiplication is obtained. If a segregation of elements is observed in the vicinity of the interface between the side margin portion 20 and another dielectric ceramic layer or an internal electrode layer 15, the WDX measurement is not performed for the site where the segregation of elements is observed.

### Elements of Additives

An element of the additive added to the dielectric layers 14 and the external layer portions 12 is preferably Mg. The Mg content rate of the dielectric layers 14 and the external layer portions 12 is preferably about 0.05 mol % or greater and not greater than about 3.0 mol % with reference to 100 moles of Ti, for example. In this way, the relative permittivity of the dielectric layers 14 can be increased so that the electrostatic capacitance of the multilayer ceramic capacitor 1 can be enhanced. In the meantime, it may be preferable that the Mg content rate of the dielectric layers 14 and the external layer portions 12 is as low as possible.

An element of the additive added to the side margin portions 20 is preferably Si. The Si content rate of the side margin portions 20 is preferably about 0.05 mol % or greater and not greater than about 5.0 mol % with reference to 100 moles of Ti, for example. The Si content rate of the side margin portions 20 is preferably higher than the Si content rate of the dielectric layers 14 and the external layer portions 12. Increasing the Si content rate of the side margin portions 20 can enhance the sinterability of the side margin portions 20 to reduce or prevent the internal electrode layers 15 from deteriorating due to the entry of, for example, moisture from the side surfaces B of the multilayer body 2.

An element of the additive added to the side margin portions 20 is preferably Mg. The Mg content rate of the side margin portions 20 is preferably about 0.05 mol % or greater and not greater than about 5.0 mol % with reference to 100 moles of Ti, for example. The Mg content rate of the side margin portions 20 is preferably higher than the Mg content rate of the dielectric layers 14 and the external layer portions 12. Increasing the Mg content rate of the side margin portions 20 can reduce or prevent the grain growth of the ceramic grains included in the side margin portions 20, with the result that shorting between internal electrode layers 15 is less likely to occur.

An element of the additive added to the side margin portions 20 is preferably Mn. The Mn content rate of the side margin portions 20 is preferably about 0.01 mol % or greater and not greater than about 3.0 mol % with reference to 100 moles of Ti, for example. The Mn content rate of the side margin portions 20 is preferably higher than the Mn content rate of the dielectric layers 14 and the external layer portions 12. Increasing the Mn content rate of the side margin portions 20 can reduce or prevent the grain growth of the ceramic grains included in the side margin portions 20, with the result that shorting between internal electrode layers 15 is less likely to occur.

### Segregation of Elements

Elements originating from a dielectric layer 14 may be segregated in a portion of a side margin portion 20 in the vicinity of the interface between the side margin portion 20 and the dielectric layer 14. Elements originating from an external layer portion 12 may be segregated in a portion of a side margin portion 20 in the vicinity of the interface between the side margin portion 20 and the external layer portion 12.

Elements originating from a dielectric layer 14 may be segregated in a portion of an internal electrode layer 15 in the vicinity of the interface between the internal electrode layer 15 and the dielectric layer 14. The segregated elements are preferably Ni. Elements originating from an external layer portion 12 may be segregated in a portion of an internal electrode layer 15 in the vicinity of the interface between the internal electrode layer 15 and the external layer portion 12. The segregated elements are preferably Ni.

Si is segregated in a portion of an internal electrode layer 15 in the vicinity of the interface between the internal electrode layer 15 and a side margin portion 20. The internal electrode layer 15 has formed therein a segregated region of Si that is located within a range extending, by a spacing distance of about 0.5 μm or shorter, for example, from the edge portion of the internal electrode layer on the side-margin-part-20 side toward the midsection of the internal electrode layer in the width direction W. As a result, the bending strength of the internal electrode layer 15 is enhanced.

### Void Amount of Multilayer Body 2

The dielectric layers 14, the external layer portions 12, and the side margin portions 20 may have an equal void amount or may each have a different void amount.

For the calculation of the void amounts, a cut section on which the dielectric layers 14, the external layer portions 12, and the side margin portions 20 are exposed as a result of cutting the multilayer ceramic capacitor 1 is observed with a scanning electron microscope (SEM) at 20000-fold magnification. Regions having a visual field size of about 6.3 μm×4.4 μm, for example, are imaged at five sites such that these regions do not overlap each other, and the proportion of the area of voids to the entire visual field is calculated using each acquired SEM image through an image analysis. The average of the calculated proportions for five visual fields is defined as a void amount.

However, when the side margin portion 20 includes a plurality of layers, the void amounts of the individual layers are separately determined, then the dimensions of the individual layers in the width direction W are divided by the dimension of the side margin portion 20 in the width direction W, the products of the individual values obtained as a result of the division and the void amounts of the individual layers are determined, and the total sum of the products is defined as the void amount of the side margin portion 20.

### Comparison Between Inner Layers 21 and Outer Layers 22

### Content of Elements

The Si content of the outer layers 22 is higher than the Si content of the inner layers 21. In this way, the bending strength of the side margin portions 20 can be enhanced. In addition, the side margin portions 20 can be reduced or prevented from being cracked or chipped, thereby increasing the moisture resistance reliability of the multilayer ceramic capacitor 1.

Si is added to the outer layers 22 such that the mole ratio of Si to 1 mole of Ti is about 3.0 or higher and not higher than about 7.0, for example. Meanwhile, Si is added to the inner layers 21 such that the mole ratio of Si to 1 mole of Ti is about 1.0 or higher and not higher than about 4.0, for example. In particular, the outer layers 22 have more segregated portions of Si than the inner layers 21.

The content of Ba as an additive in the inner layers 21 is higher than the content of Ba as an additive in the outer layers 22. The content of Ba as an additive in the outer layers 22 is higher than the content of Ba as an additive in the dielectric layers 14. Thus, the content of Ba as an additive in the inner layers 21, the content of Ba as an additive in the outer layers 22, and the content of Ba as an additive in the dielectric layers 14 are different from each other. The difference in Ba content can be identified by TEM.

The Ba content of the inner layers 21 is adjusted such that the center value of the mole ratio of Ba to 1 mole of Ti is higher than about 1.020 and lower than about 1.040, for example. The Ba content of the outer layers 22 is adjusted such that the center value of the mole ratio of Ba to 1 mole of Ti is higher than about 1.01 and not higher than about 1.020, for example. The Ba content of the dielectric layers 14 is adjusted such that the center value of the mole ratio of Ba to 1 mole of Ti is higher than about 0.99 and lower than about 1.01, for example.

The mole ratios can each be identified through a process in which, a portion of an inner layer 21, an outer layer 22, or a dielectric layer 14 in the vicinity of a surface thereof is peeled off from the multilayer ceramic capacitor 1, and acquired powder is dissolved in an acid, and the solution is subjected to ICP analysis.

The content of Ba as an additive in the inner layers 21 is greater than about 100% and less than about 140% with reference to the content of Ba as an additive in the outer layers 22, for example.

### Voids

The side margin portions 20 are each formed such that the number of voids decreases in the direction from the internal layer portion 11 toward the side distant from the internal layer portion 11. The outer layers 22 have fewer voids than the inner layers 21. In this way, it is possible to reduce or prevent infiltration of moisture and the like into the multilayer body 2 through the side margin portion 20, so that the moisture resistance reliability of the multilayer ceramic capacitor 1 can be enhanced.

### Additives

An element included as an additive in the inner layers 21 is preferably different from an element included as an additive in the outer layers 22. When doing so, infiltration of moisture into the multilayer ceramic capacitor 1 can be reduced or prevented owing to the outer layers 22, while allowing the inner layers 21 to increase the adhesion between the side margin portions 20 and the internal layer portion 11.

It is considered that the inner layers 21 and the outer layers 22 may be incapable of being visually distinguished from each other. In such a situation, the inner layers 21 and the outer layers 22 can be distinguished from each other on the basis of, for example, the difference in type or content of elements included therein.

### Dimensions in Width Direction W

The dimension of the outer layers 22 in the width direction W is preferably larger than the dimension of the inner layers 21 in the width direction W. By doing so, the effect of the outer layers 22 reducing or preventing moisture infiltration can be prominent.

It is preferable that the dimension of the outer layers 22 in the width direction W is about 5 μm or greater and not greater than about 20 μm and that the dimension of the inner layers 21 in the width direction W is preferably about 0.1 μm or greater and not greater than about 20 μm, for example. In this way, the moisture resistance reliability of the multilayer ceramic capacitor 1 can be enhanced effectively while increasing the adhesion between the side margin portions 20 and the internal layer portion 11.

### External Electrodes 3

The external electrodes 3 include a first external electrode 3A provided on the first end surface CA of the multilayer body 2, and a second external electrode 3B provided on the second end surface CB of the multilayer body 2. When the first external electrode 3A and the second external electrode 3B do not particularly need to be distinguished from each other for description, both are referred to as external electrodes 3. The external electrodes 3 cover not only the end surfaces C but also portions of the main surfaces A and the side surfaces B on the end-surface-C sides.

The external electrodes 3 each include a base electrode layer 31 and a plating layer 32 (see FIG. 2).

For example, the base electrode layer 31 may include at least one of a fired layer, an electrically conductive resin layer, and a thin film layer. The base electrode layer 31 only needs to be disposed on at least an end surface C, and does not need to extend onto a main surface A or a side surface B.

When fired layers are the base electrode layers 31, the fired layers include a glass component and a metal. As described in detail hereinafter, the fired layers are formed by applying and then firing an electrically conductive paste including an electrically conductive metal and glass.

The glass component of the fired layers may include an oxide including at least one of B, Si, Ba, Mg, Al, or Ti. The oxide is preferably SiO₂, Al₂O₃, TiO₂, BaO₂, or ZrO₂. It is more preferable that the glass component of the fired layers includes an oxide including Ba or Ti. This oxide is preferably BaO₂ or TiO₂. When including BaO₂ or TiO₂, the glass component has a low impurity content and is excellent in flexibility.

For example, a metal for the fired layers may be at least one of Cu, Ni, Ag, Pd, Ag—Pd alloys, or Au.

With respect to the portions of the fired layers disposed on the end surfaces C, the thicknesses (dimensions in the lengthwise direction L) of the midsections of these portions as viewed in the lamination direction T are each preferably about 3 μm or greater and not greater than about 100 μm, for example.

With respect to the portions of the fired layers disposed on the main surfaces A, the thicknesses (dimensions in the lamination direction T) of the midsections of these portions as viewed in the lengthwise direction L are each preferably about 3 μm or greater and not greater than about 70 μm, for example.

With respect to the portions of the fired layers disposed on the side surfaces B, the thicknesses of the midsections of these portions as viewed in the lengthwise direction L are each preferably about 3 μm or greater and not greater than about 70 μm, for example.

When electrically conductive resin layers are the base electrode layers 31, the electrically conductive resin layers include a metal and a thermosetting resin.

A metal in the electrically conductive resin layers imparts conductivity to the electrically conductive resin layers. A metal in the electrically conductive resin layers may be Ag, Cu, Ni, Sn, Bi, or an alloy including the same.

A metal in the electrically conductive resin layers may be a metal powder having an Ag-coated surface. The coated metal powder (parent material) is preferably Cu, Ni, Sn, Bi, or an alloy including the same. When doing so, the performance of the base electrode layers 31 can be enhanced owing to characteristics of Ag, such as a low specific resistance and resistance to oxidation. In addition, a cost increase can be reduced or prevented using the inexpensive metal as a parent material.

A metal in the electrically conductive resin layers may also be Cu or Ni that has been subjected to antioxidation treatment.

A metal in the electrically conductive resin layers may also be a metal powder having a surface coated with Si, Ni, or Cu. The coated metal powder (parent material) is preferably Ag, Cu, Ni, Sn, Bi, or an alloy including the same.

For example, a metal in the electrically conductive resin layers may be a spherical metal powder or a flattened metal powder. A mixture of a spherical metal powder and a flattened metal powder is preferably used as a metal in the electrically conductive resin layers.

A thermosetting resin imparts flexibility to the electrically conductive resin layers. As a result, when the multilayer ceramic capacitor 1 is subjected to physical impacts or impacts resulting from a heat cycle, the electrically conductive resin layers can appropriately function as cushioning layers. Hence, the occurrence of cracking in the multilayer ceramic capacitor 1 can be reduced or prevented.

For example, the thermosetting resin may be selected from various types of publicly known thermosetting resins, such as epoxy resins, phenolic resins, urethane resins, silicone resins, or polyimide resins. The thermosetting resin is preferably an epoxy resin. The epoxy resin is excellent in heat resistance, moisture resistance, adhesion, etc., and thus can further enhance the performance of the electrically conductive resin layers.

The electrically conductive resin layer preferably includes a curing agent. For example, when the thermosetting resin is an epoxy resin, the curing agent can be selected from various types of publicly known compounds, such as phenolic compounds, amine compounds, acid anhydride compounds, imidazole compounds, active ester compounds, or amide-imide compounds.

The thickest portion of the electrically conductive resin layer preferably has a thickness of about 10 μm or greater and not greater than about 150 μm, for example.

The electrically conductive resin layer may be provided directly on the multilayer body 2, or may be provided on the outside of a fired layer provided on the multilayer body 2. When the electrically conductive resin layer is provided on the outside of a fired layer, the electrically conductive resin layer may cover the entirety of the outside of the fired layer, or may cover only a portion thereof.

The electrically conductive resin layer may have a single-layer structure or a multilayer structure.

When the base electrode layer 31 is a thin film layer, the thin film layer is formed by depositing metal particles. The thin film layer has a layer thickness of about 1 μm or less, for example. As described in detail hereinafter, the thin film layer is formed using a thin film formation method such as a sputtering method or an evaporation method.

For example, the plating layer 32 includes at least one of Cu, Ni, Sn, Ag, Pd, Ag—Pd alloys, or Au.

The plating layer 33 includes a first plating layer 331 disposed on the base electrode layer 31, and a second plating layer 332 disposed on the first plating layer 331. The plating layer 33 does not need to have a two-layer structure, but may have a single-layer structure or a multilayer structure consisting of three or more layers.

The first plating layer 331 is preferably a Ni-plating layer. In this way, the base electrode layer 31 can be reduced or prevented from being eroded by solder when mounting the multilayer ceramic capacitor 1 onto a circuit board. The layer thickness of the first plating layer 331 is preferably about 1 μm or greater and not greater than about 15 μm, for example.

The second plating layer 332 is preferably a Sn-plating layer. In this way, solder wettability is enhanced when mounting the multilayer ceramic capacitor 1 onto the circuit board, such that the multilayer ceramic capacitor 1 is easily mounted. The layer thickness of the second plating layer 332 is preferably about 1 μm or greater and not greater than about 15 μm, for example.

### Cover Regions 4

With respect to the multilayer ceramic capacitor 1, moisture and the like may infiltrate into the multilayer ceramic capacitor 1 through the boundaries between the side margin portions 20 and the multilayer body chip 10. Accordingly, the multilayer ceramic capacitor 1 includes cover regions 4. In the figures, the cover regions 4 are indicated with dot hatch patterns.

The cover regions 4 each includes an inorganic material. The inorganic material forming the cover regions 4 includes at least one of Si, Ti, Ba, or Zr. In this way, the compactness of the cover regions 4 can be ensured, so that water and the like can be reduced or prevented from passing through the cover regions 4. The inorganic material forming the cover regions 4 is preferably Si. As a result, the effect of enhanced moisture resistance can be achieved through firing at a lower temperature.

The cover regions 4 include a first cover region 4A and a second cover region 4B. When the first cover region 4A and the second cover region 4B do not particularly need to be distinguished from each other, both may hereinafter be referred to as “cover regions 4.”

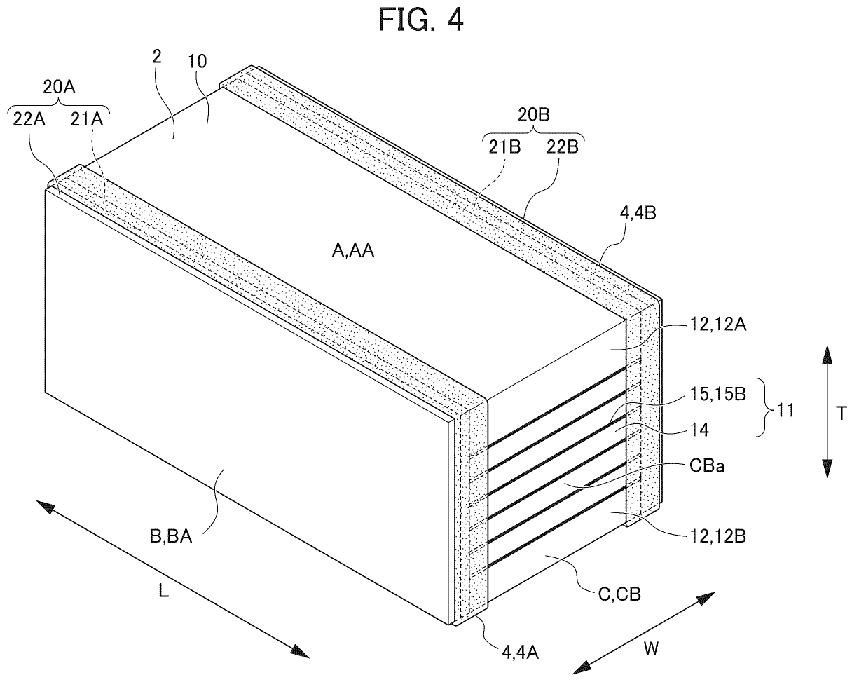

The first cover region 4A assumes a strip shape and is disposed so as to span, on the main surfaces A of the multilayer body 2, the boundaries between the first side margin portion 20A and the external layer portions 12 and span, on the end surfaces C of the multilayer body 2, the boundaries between the first side margin portion 20A and the internal layer portion 11. The first cover region 4A has a loop shape surrounding an area in the lengthwise direction L (see FIG. 4). The first cover region 4A covers the entirety of the boundaries between the first side margin portion 20A and the external layer portions 12. The first cover region 4A covers the entirety of the boundaries between the first side margin portion 20A and the internal layer portion 11.

The second cover region 4B assumes a strip shape and is disposed so as to span, on outer surfaces of the multilayer body 2, the boundaries between the second side margin portion 20B and the external layer portions 12 and span, on the end surfaces C of the multilayer body 2, the boundaries between the second side margin portion 20B and the internal layer portion 11. The second cover region 4B has a loop shape surrounding an area in the lengthwise direction L. The second cover region 4B covers the entirety of the boundaries between the second side margin portion 20B and the external layer portions 12. The second cover region 4B covers the entirety of the boundaries between the second side margin portion 20B and the internal layer portion 11.

In these ways, it is possible to reduce or prevent infiltration of moisture and the like into the multilayer ceramic capacitor 1 through the boundaries between the side margin portions 20 and the multilayer body chip 10, so that the moisture resistance reliability of the multilayer ceramic capacitor 1 can be enhanced.

The thickness of the first cover region 4A is preferably about 1 μm or greater and not greater than about 10 μm, for example. The thickness of the second cover region 4B is preferably about 1 μm or greater and not greater than about 10 μm, for example. In this way, the multilayer ceramic capacitor 1 can be made small in height while ensuring the moisture resistance reliability of the multilayer ceramic capacitor 1.

The first end surface CA includes a first uncovered section CAa covered with neither the first cover region 4A nor the second cover region 4B. The first end surface CA is connected to the first external electrode 3A at the first uncovered section CAa.

The second end surface CB includes a second uncovered section CBa covered with neither the first cover region 4A nor the second cover region 4B. The second end surface CB is connected to the second external electrode 3B at the second uncovered section CBa.

When the first uncovered section CAa and the second uncovered section CBa do not particularly need to be distinguished from each other, both may hereinafter be referred to as “uncovered sections Ca.”

The dimension of the first cover region 4A in the width direction W is preferably about 10% or greater of the dimension of the multilayer body 2 in the width direction W, and not greater than about 20% of the dimension of the multilayer body 2 in the width direction W, for example. The dimension of the second cover region 4B in the width direction W is preferably about 10% or greater of the dimension of the multilayer body 2 in the width direction W, and not greater than about 20% of the dimension of the multilayer body 2 in the width direction W. In this way, the moisture resistance reliability of the multilayer ceramic capacitor 1 can be enhanced while sufficiently ensuring the connection between the end surfaces C and the external electrodes 3.

The shape of the boundary lines between the cover regions 4 and the multilayer body 2 is not particularly limited. The boundary lines between the cover regions 4 and the multilayer body 2 may be identified by observing the cover regions 4 and the multilayer body 2 with an optical microscope under dark-field condition. When the boundary lines can be identified, the cover regions 4 can also be recognized as cover layers. Meanwhile, when the cover regions 4 are integrated with the multilayer body 2, no boundary lines may be identified between the cover regions 4 and the multilayer body 2. In this case, on the assumption that the main surfaces A and the side surfaces B of the multilayer body 2 are flat surfaces, it is determined that portions projecting from the flat surfaces are the cover regions 4.

### Method for Manufacturing Multilayer Ceramic Capacitors

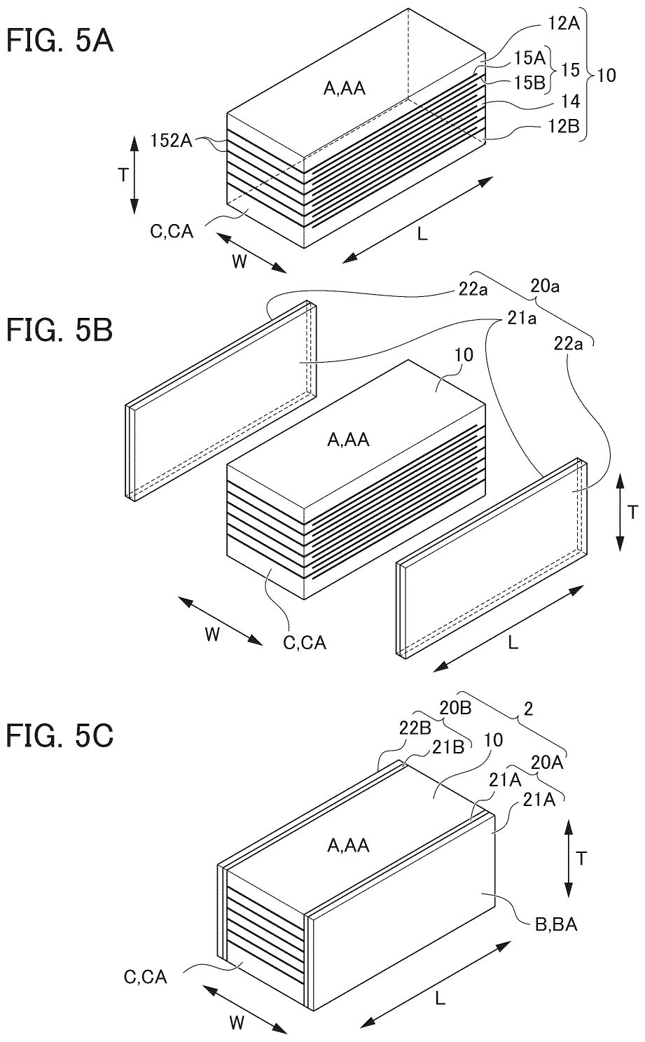

The following describes a non-limiting example of a method for manufacturing the multilayer ceramic capacitor 1 with references to FIGS. 5 to 7. FIGS. 5 to 7 each illustrate a manufacturing step for the multilayer ceramic capacitor.

The manufacturing steps for the multilayer ceramic capacitor 1 include a multilayer-body manufacturing step, a cover-region formation step, and an external-electrode formation step.

### Multilayer-Body Manufacturing Step

The multilayer-body manufacturing step includes a multilayer-body-chip manufacturing step and a side-margin-part formation step.

### Multilayer-Body-Chip Manufacturing Step

First, ceramic green sheets for stacking provided by forming ceramic slurry into sheet shapes are prepared. The ceramic green sheets for stacking include a ceramic raw material including a dielectric ceramic material, a binder, and a solvent. An additive including rare-earth elements may be added to the ceramic raw material. Changing elements included in the additive allows the dielectric layers 14, the external layer portions 12, and the side margin portions 20 to each have a different composition.

An electrically conducting paste to constitute the internal electrode layer is printed on the stack ceramic green sheets. The electrically conducting paste is printed on surfaces of the stack ceramic green sheet such that a plurality of stripes are arranged in the width direction of the stripes. For example, a screen printing method or a gravure printing method can be used as a method for printing the electrically conducting paste.

A prescribed number of ceramic green sheets are stacked on which an electrically conducting paste is not printed. Then, a prescribed number of the ceramic green sheets on which the electrically conducting paste is printed are stacked so as to alternately deviate in an arrangement direction in which a plurality of lines of the electrically conducting paste are arranged for printing. Thereafter, a prescribed number of the ceramic green sheets on which an electrically conducting paste is not printed are stacked. As a result, a mother multilayer body is provided.

The mother multilayer body is pressed. For example, a method such as rigid body pressing or isostatic pressing can be used as a method for pressing the mother multilayer body.

The pressed mother multilayer body is cut into a chip shape. As a result, the multilayer body chip 10 is provided as depicted in FIG. 5A. For example, a method such as hand press cutting, dicing, or laser cutting can be used as a method for cutting the mother multilayer body.

Only the electrically conductive paste to constitute the first internal electrode layers 15A, from among the internal electrode layers 15, is exposed on one end surface, from among the pair of end surfaces of the multilayer body chip 10, and only the electrically conductive paste to constitute the second internal electrode layers 15B, from among the internal electrode layers 15, is exposed on the other end surface. Both the electrically conductive paste to constitute the first internal electrode layers 15A and the electrically conductive paste to constitute the second internal electrode layers 15B are exposed on the pair of side surfaces of the multilayer body chip 10. With respect to the pair of side surfaces of the multilayer body chip 10, the edge portions of the electrically conductive paste on each of the side-surface sides of the multilayer body chip 10 are even with each of the side surfaces of the multilayer body chip 10.

### Side-Margin-Part Formation Step

Inner-layer ceramic slurry for preparing an inner-layer ceramic green sheet is produced. The inner-layer ceramic slurry includes a dielectric ceramic material including, for example, BaTiO₃ as a main component, a binder, and a solvent. Si may be added to the inner-layer ceramic slurry as a sintering additive. The inner-layer ceramic slurry may include a metal of a liquid phase type. The inner-layer ceramic slurry may have added thereto Mg, Mn, or a larger amount of rare-earth elements than the ceramic green sheets for forming the multilayer body chip 10.

Outer-layer ceramic slurry for preparing an outer-layer ceramic green sheet is produced. The outer-layer ceramic slurry includes a dielectric ceramic material including, for example, BaTiO₃ as a main component, a binder, and a solvent. Si may be added to the outer-layer ceramic slurry as a sintering additive.

The amount of Si included in the inner-layer ceramic green sheet is preferably larger than the amount of Si included in the outer-layer ceramic sheet. Cross sections of the inner-layer ceramic green sheet and the outer-layer ceramic green sheet are imaged through WDX, and the amounts of Si included in the inner-layer ceramic sheet and the outer-layer ceramic sheet are determined on the basis of the sizes of the areas of regions in which Si is detected.

The outer-layer ceramic slurry is applied to a surface of a resin film and then dried. As a result, an outer-layer ceramic green sheet 22a is formed on the resin film. The inner-layer ceramic slurry is applied to the surface of the outer-layer ceramic green sheet and then dried. As a result, an inner-layer ceramic green sheet 21a is formed on the outer-layer ceramic green sheet. In this way, side-margin ceramic green sheets 20a having a two-layer structure is provided as depicted in FIG. 5B.

For example, the side-margin ceramic green sheet 20a having a two-layer structure may also each be provided by laminating a preformed outer-layer ceramic green sheet 22a and a preformed inner-layer ceramic green sheet 21a on each other.

The side-margin ceramic green sheet 20a is stripped from the resin film.

The side-margin ceramic green sheet 20a are each pressed against the multilayer body chip 10 and stamped by the multilayer body chip 10, with the surface of the side-margin ceramic green sheet 20a on the inner-layer side and the surface of the multilayer body chip 10 on the side-surface-B side being opposed to each other. In this way, the side margin portions 20 are formed on the multilayer body chip 10. As a result, the multilayer body 2 is provided as depicted in FIG. 5C. Note that an organic solvent to serve as an adhesive is preferably applied to the side surfaces of the multilayer body chip 10 in advance.

The multilayer body 2 is preferably subjected to, for example, barrel polishing. In this way, corners and ridge line portions of the multilayer body 2 are rounded.

The multilayer body 2 is degreased in a nitrogen atmosphere. Then, the multilayer body 2 is fired in a mixed atmosphere of nitrogen, hydrogen, and water vapors. For example, the temperature during the firing of the multilayer body 2 is preferably about 900° C. or higher and not higher than about 1300° C., for example.

### Cover-Region Formation Step

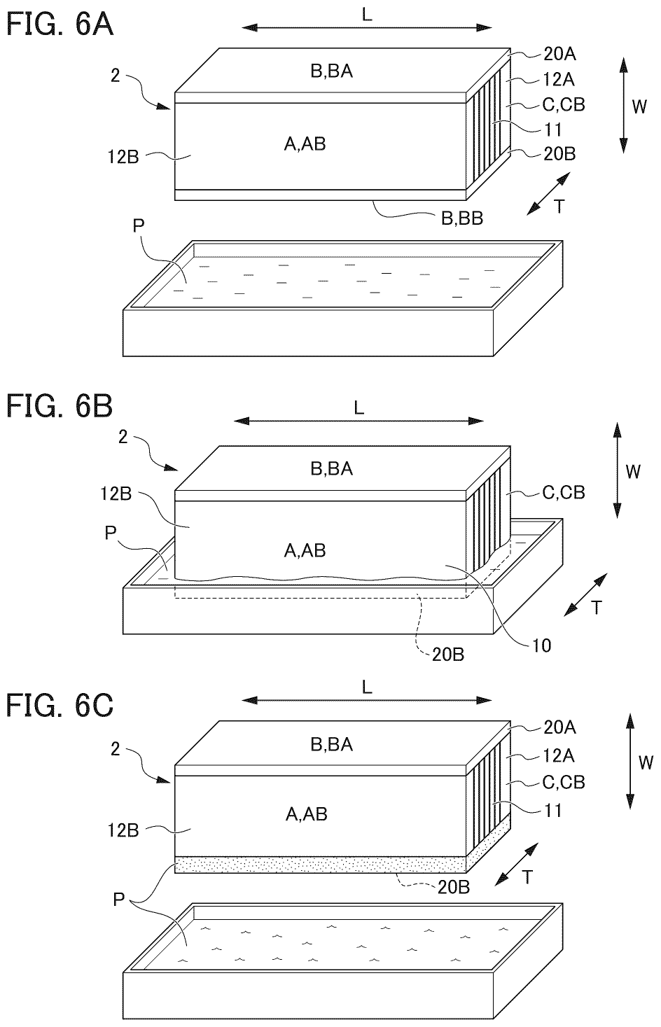

First, as depicted in FIG. 6A, the multilayer body 2 is arranged such that the second side surface BB faces downward.

As depicted in FIG. 6B, a paste bath filled with a cover-region paste P to form the cover regions 4 is prepared. The cover-region paste P includes an inorganic material of at least one type from among Si, Ti, Ba, and Zr. The multilayer body 2 is dipped into the cover-region paste P, with the second side surface BB facing downward. In this case, portions of the multilayer body 2 on the second-side-surface-BB side are dipped into the cover-region paste P, in particular, at least portions of the multilayer body 2 that include the boundary between the multilayer body chip 10 and the second side margin portion 20B are dipped into the cover-region paste P. When doing so, the dimension of the cover region 4 in the width direction W can be adjusted by adjusting the depth to which the multilayer body 2 is dipped into the cover-region paste P.

As depicted in FIG. 6C, the multilayer body 2 is pulled up from the paste bath filled with the cover-region paste P. The multilayer body 2 is in a state in which the cover-region paste P has been applied to the entirety of the second side surface BB, portions of the main surfaces A on the second-side-surface-BB side, and portions of the end surfaces C on the second-side-surface-BB side. The cover-region paste P is disposed so as to span the boundaries between the second side margin portion 20B and the external layer portions 12. The cover-region paste P is disposed so as to span the boundaries between the second side margin portion 20B and the internal layer portion 11.

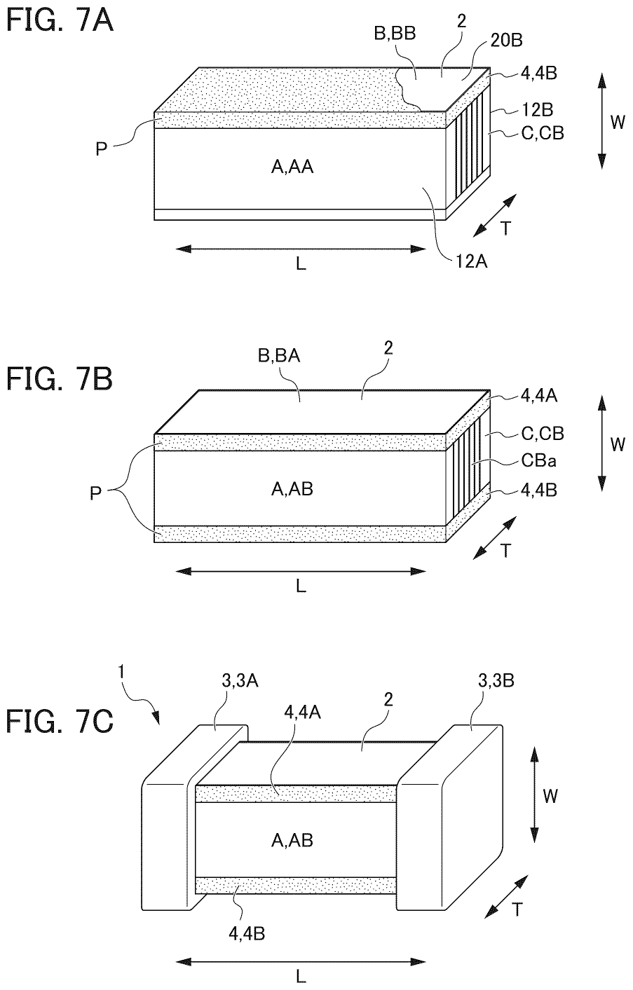

As depicted in FIG. 7A, unnecessary portions of the cover-region paste P disposed on the multilayer body 2 are scrapped off. For example, a portion of the cover-region paste P that is disposed on the second side surface BB is scrapped off. Meanwhile, adjustments are made such that the cover region 4 has a desired thickness and a desired dimension in the width direction W. The scrapping-off of the cover-region paste P does not necessarily need to be performed, but may be performed according to need. Then, the cover-region paste P is dried so as to constitute the second cover region 4B. The drying temperature and the drying time in this process are set, as appropriate, according to the type of the cover-region paste P. In this way, the second cover region 4B is formed on the multilayer body 2. Note that the orientation of the multilayer body 2 in FIG. 7A is achieved by rotating the multilayer body 2 in FIG. 6C by 1800 around an axis in the lengthwise direction L.

Thereafter, the first cover region 4A is formed on the first-side-surface-BA side of the multilayer body 2 by performing the aforementioned steps of the cover-region formation step again with the orientation of the multilayer body 2 having been changed. In this way, as depicted in FIG. 7B, the first cover region 4A and the second cover region 4B are formed on the multilayer body 2. Meanwhile, the order in which the first cover region 4A and the second cover region 4B are formed on the multilayer body 2 is not limited to the aforementioned order. The orientation of the multilayer body 2 in FIG. 7B is achieved by rotating the multilayer body 2 in FIG. 7A by 1800 around an axis in the lengthwise direction L.

### External-Electrode Formation Step

First, the base electrode layers 31 are formed on the end surfaces C of the multilayer body 2. For example, the base electrode layers 31 are formed as fired layers. The end surfaces C of the multilayer body 2 are sequentially soaked in an electrically conductive paste that is an electrode material for base electrodes. As a result, the electrically conductive paste is applied to each of the end surfaces C of the multilayer body 2. Thereafter, the electrically conductive paste is fired together with the multilayer body 2. For example, the firing temperature is about 700° C. or higher and not higher than about 900° C. In this way, the base electrode layers 31 are formed on the end surfaces C of the multilayer body 2. The end surfaces of the multilayer body 2 are connected to the base electrode layers 3 at the uncovered sections Ca.

The fired layers may include a ceramic component. In this case, the fired layers may include a ceramic component in place of a glass component, or may include both a glass component and a ceramic component. The ceramic component is preferably similar to the ceramic component of the multilayer body 2. For the fired layers including a ceramic component, it is preferable that: the electrically conductive paste for the base electrodes is applied to the multilayer body 2 before firing; and the multilayer body 2 and the electrically conducting paste for the base electrodes are concurrently fired. The firing temperature is preferably about 900° C. or higher and not higher than about 1300° C., for example.

Next, the first plating layer 331 is formed on the base electrode layer 31. The first plating layer 331 is formed such that the edge portions of the first plating layer 331 on the main-surface-A sides and the side-surface-B sides cover the edge portions of the base electrode layer 31 on the main-surface-A sides and the side-surface-B sides. For example, the first plating layer 331 is a Ni-plating layer. For example, the first plating layer 331 can be formed by barrel plating.

Next, the second plating layer 332 is formed on the first plating layer 331. The second plating layer 332 is formed such that the edge portions of the second plating layer 332 on the main-surface-A sides and the side-surface-B sides cover the edge portions of the first plating layer 321 on the main-surface-A sides and the side-surface-B sides. For example, the second plating layer 322 is a Sn-plating layer. For example, the second plating layer 332 can be formed by barrel plating.

Through the abovementioned steps, the multilayer ceramic capacitor 1 is manufactured with the external electrodes 3 formed on the multilayer body 2, as depicted in FIG. 7C.

The base electrode layer 31 may also be formed as an electrically conductive resin layer. The electrically conductive resin layer may be formed on the surface of a fired layer or may be formed directly on the surface of the multilayer body 2.

First, an electrically conductive paste including a thermosetting resin and a metal component is applied to a fired layer or the multilayer body 2. Then, a heat treatment is performed at a temperature of about 250° C. or higher and not higher than about 550° C., for example. As a result, the thermosetting resin is solidified, thereby forming the electrically conductive resin layer. The heat treatment is preferably performed in a nitrogen atmosphere. The heat treatment is preferably performed with an oxygen concentration of about 100 ppm or lower, for example. In this way, scattering of resin and oxidization of metal are reduced or prevented.

The base electrode layer 31 may also be formed as a thin film layer. In this case, a layer of deposited metal particles is formed using a thin film formation method such as a sputtering method or an evaporation method. As a result, a thin film layer is formed. The layer thickness of the thin film layer is about 1 μm or less, for example.

In the meantime, the base electrode layers 31 are not absolutely necessary, and plating layers may be formed directly on the multilayer body 2. When doing so, base plating films are formed on the end surfaces C of the multilayer body 2 by plating. The plating may be an electroplating method or an electroless plating method. However, the plating is preferably an electroplating method in that this method involves simpler steps. A plating technique is preferably barrel plating. If necessary, plating electrodes may be further formed on the surfaces of the plating layers by using a similar method.

### Effects

The above example embodiments can provide the following effects.

In the above-described example embodiments, the first cover region 4A includes an inorganic material and is positioned on outer surfaces of the multilayer body 2 so as to span the boundaries between the first side margin portion 20A and the external layer portions 12. The second cover region 4B includes an inorganic material and is positioned on outer surfaces of the multilayer body 2 so as to span the boundaries between the second side margin portion 20B and the external layer portions 12. In this way, it is possible to reduce or prevent infiltration of moisture into the multilayer ceramic capacitor 1 through the boundaries between the side margin portions 20 and the external layer portions 12, so that the moisture resistance reliability of the multilayer ceramic capacitor 1 can be enhanced.

In the above-described example embodiments, the inorganic material forming the cover regions 4 includes at least one of Si, Ti, Ba, or Zr. In this way, the compactness of the cover regions 4 can be enhanced. Hence, infiltration of moisture into the multilayer ceramic capacitor 1 can be appropriately reduced or prevented, so that the moisture resistance reliability of the multilayer ceramic capacitor 1 can be appropriately enhanced.

In the above-described example embodiments, the first cover region 4A has a loop shape surrounding an area in the lengthwise direction L. The second cover region 4B has a loop shape surrounding an area in the lengthwise direction L. In this way, the cover regions 4 can cover the entirety of the boundaries between the side margin portions 20 and the external layer portions 12. The cover regions 4 can also cover the entirety of the boundaries between the side margin portions 20 and the internal layer portion 11. As a result, infiltration of moisture into the multilayer ceramic capacitor can be appropriately reduced or prevented, so that the moisture resistance reliability of the multilayer ceramic capacitor 1 can be appropriately enhanced.

In the above-described example embodiments, the thickness of the first cover region 4A is preferably about 1 μm or greater and not greater than about 10 μm, for example. The thickness of the second cover region 4B is preferably about 1 μm or greater and not greater than about 10 μm, for example. In this way, the moisture resistance reliability of the multilayer ceramic capacitor 1 can be enhanced while making the multilayer ceramic capacitor 1 small in height.

In the above-described example embodiments, the dimension of the first cover region 4A in the width direction W is preferably about 10% or greater of the dimension of the multilayer body 2 in the width direction W, and not greater than about 20% of the dimension of the multilayer body 2 in the width direction W, for example. The dimension of the second cover region 4B in the width direction W is preferably about 10% or greater of the dimension of the multilayer body 2 in the width direction W, and not greater than about 20% of the dimension of the multilayer body 2 in the width direction W, for example. In this way, the moisture resistance reliability of the multilayer ceramic capacitor 1 can be enhanced while sufficiently ensuring the connection between the end surfaces C and the external electrodes 3.

In the above-described example embodiments, the dimension of the first side margin portion 20A in the width direction W is preferably about 5 μm or greater and not greater than about 40 μm, for example. The dimension of the second side margin portion 20B in the width direction W is preferably about 5 μm or greater and not greater than about 40 μm, for example. In this way, the moisture resistance reliability of the multilayer ceramic capacitor 1 can be enhanced while increasing the capacitance of the multilayer ceramic capacitor 1.

With respect to the side margin portions 20, for example, the adhesion between the internal layer portion 11 and the surfaces of the side margin portions 20 on the internal-layer-part-11 side is desirably high in order to reliably fix the side margin portions 20 to the internal layer portion 11. The surface of each of the side margin portions 20 on the opposite side from the internal-layer-part-11 side does not need to have adhesion to the internal layer portion 11, but is desirably capable of appropriately reducing or preventing infiltration of moisture into the multilayer ceramic capacitor 1. Thus, required functions differ between the portions of the side margin portion 20 on the internal-layer-part-11 side and the portions thereof on the side distant from the internal layer portion 11.

In the above-described example embodiments, the side margin portions 20 each includes two layers, one of which is an inner layer 21 disposed on the internal-layer-part-11 side, and the other is an outer layer 22 disposed on the side distant from the internal layer portion 11. Thus, for example, differing the amount of included resin between the inner layer 21 and the outer layer 22 can impart a different characteristic to each of the inner layer 21 and the outer layer 22. In this way, for example, infiltration of moisture into the internal layer portion 11 can be appropriately reduced or prevented owing to the outer layer 22, with the adhesion between the side margin portion 20 and the internal layer portion 11 being increased by the inner layer 21.

In the above-described example embodiments, an element included as an additive in the inner layer 21 is preferably different from an element included as an additive in the outer layer 22. By doing so, a different characteristic can be imparted to each of the inner layer 21 and the outer layer 22 so that the side margin portion 20 can be more functional.

In the above-described example embodiments, the dimension of the outer layers 22 in the width direction W is preferably larger than the dimension of the inner layers 21 in the width direction W. By doing so, the effect of the outer layers 22 reducing or preventing moisture infiltration can be made prominent.

In the above-described example embodiments, the dimension of the inner layers 21 in the width direction W is preferably about 0.1 μm or greater and not greater than about 20 μm, for example. The dimension of the outer layers 22 in the width direction W is preferably about 5 μm or greater and not greater than about 20 μm, for example. In this way, the moisture resistance reliability of the multilayer ceramic capacitor 1 can be enhanced effectively while increasing the adhesion between the side margin portions 20 and the internal layer portion 11.

In the above-described example embodiments, the thickness of each of the internal electrode layers 15 is preferably about 0.8 μm or less, for example. In this way, the number of layers to be stacked can be increased even with the size of the multilayer body 2 remaining the same, so that the electrostatic capacitance of the multilayer ceramic capacitor 1 can be ensured.

In the above-described example embodiments, the thickness of each of the dielectric layers 14 is preferably about 0.55 μm or less, for example. In this way, the number of layers to be stacked can be increased even with the size of the multilayer body 2 remaining the same, so that the electrostatic capacitance of the multilayer ceramic capacitor 1 can be ensured.

### Exemplary Experiment

Multilayer ceramic capacitors were produced as samples by using the manufacturing method according to the above-described example embodiments. A moisture resistance test was performed for the samples. As an example, a multilayer ceramic capacitor including a first cover region and a second cover region was prepared. As a comparative example, a multilayer ceramic capacitor including neither a first cover region nor a second cover region was prepared.

50 samples were prepared for each of the example and the comparative example.

The moisture resistance test was performed on the basis of a PCBT test method. More specifically, each sample was mounted on a wiring board with eutectic solder, and the resultant structure was placed in a high temperature and humidity tank with a temperature of 125 [° C.] and a relative humidity of 95 [% RH] under a condition in which a DC current of 2 [V] is applied between a pair of external electrodes; and this condition was maintained for 72 hours. After the test, samples that exhibited a double-digit decrease or greater in insulation resistance value in comparison with the value before the test were judged to be “faulty.” Configuration of example
Dimension of multilayer ceramic capacitor: L×W×T=1.0 mm×0.5 mm×0.5 mm
Ceramic material for dielectric layers: BaTiO₃
Capacitance: 22 μF
Rated voltage: 4 V
Metal material for internal electrode layers: Ni
Structure of external electrodes
Base electrode layers: fired layer
Material for base electrode layers: electrode including electrically conductive metal (Cu) and glass component
Thickness of base electrode layers
End surface thickness: 20 μm (thickness of central portion, in height direction, of base electrode layer disposed on end surface C)
Main surface thickness: 0.25 μm (thickness of central portion, in lengthwise direction, of base electrode layer disposed on main surface A)
Plating layers: two-layer structure of Ni-plating and Sn-plating
Ni-plating thickness:
End surface thickness: 4 μm (thickness of central portion, in height direction, of Ni-plating layer disposed on end surface C)
Main surface thickness: 4 μm (thickness of central portion, in lengthwise direction, of Ni-plating layer disposed on main surface A)
Sn-plating thickness:
End surface thickness: 4 μm (thickness of central portion, in height direction, of Sn-plating layer disposed on end surface C)
Main surface thickness: 4 μm (thickness of central portion, in lengthwise direction, of Sn-plating layer disposed on main surface A)
Structures of first cover region and second cover region
Material for first cover region and second cover region: SiO₂
Thickness of first cover region and second cover region: 5 μm
Dimension of first cover region in width direction: 15% of dimension of multilayer body in width direction
Dimension of second cover region in width direction: 15% of dimension of multilayer body in width direction

### Configuration of Comparative Example

The configuration of the comparative example is the same as that of the example except that the former includes neither of the first and second cover regions.

### Result

None of the 50 samples in the example were faulty.

4 of the 50 samples in the comparative example were faulty.

The comparison between the example and the comparative example clarified that the moisture resistance reliability of a multilayer ceramic capacitor is enhanced by providing the multilayer ceramic capacitor with cover regions.

### Variations

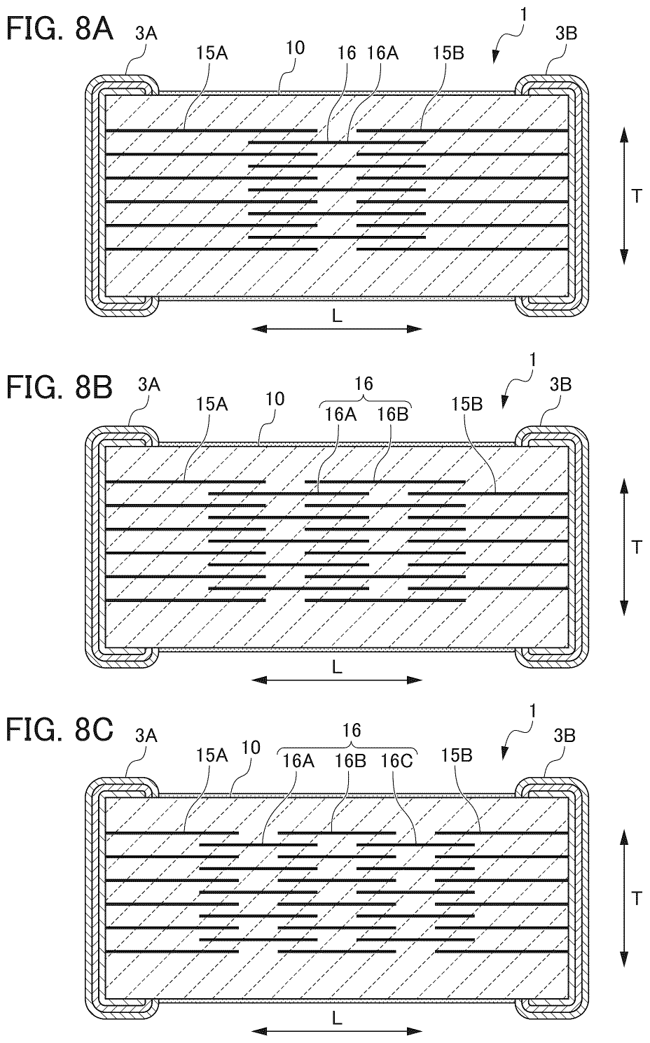

Although descriptions have been given of example embodiments of the present invention, the present invention is not limited to these and encompasses the following scope.
The multilayer ceramic capacitor 1 may have a multi-portion structure. The configuration of the multilayer ceramic capacitor 1 having a multi-portion structure is described on the basis of FIGS. 8A to 8C. FIGS. 8A to 8C, which correspond to FIG. 2, illustrate the configuration of the multilayer ceramic capacitor 1 according to a modification.

As depicted in FIGS. 8A to 8C, in addition to the first internal electrode layers 15A and the second internal electrode layers 15B, the multilayer ceramic capacitor 1 may include floating internal electrode layers 16, none of which are led to the first end surface CA or the second end surface CB.

For example, the multilayer ceramic capacitor 1 depicted in FIG. 8A has a two-portion structure including first floating internal electrode layers 16A as the floating internal electrode layers 16. The multilayer ceramic capacitor 1 depicted in FIG. 8B has a three-portion structure including first floating internal electrode layers 16A and second floating internal electrode layers 16B as the floating internal electrode layers 16. The multilayer ceramic capacitor 1 depicted in FIG. 8C has a four-portion structure including first floating internal electrode layers 16A, second floating internal electrodes 16B, and floating internal electrode layers 16C as the floating internal electrode layers 16.

Providing floating internal electrode layers 16 with the multilayer ceramic capacitor 1 divides a counter electrode portion into a plurality of sections. In this way, a plurality of capacitor components are formed between internal electrode layers opposed to each other, and are connected in series. Thus, a decreased voltage is applied to each of the capacitor components so that the withstand voltage of the multilayer ceramic capacitor 1 can be increased. Note that the multilayer ceramic capacitor 1 may have a multi-portion structure, e.g., four-portion or more-than-four-portion structure.
Although the first cover region 4A and the second cover region 4B in the above-described example embodiments are both preferably loop-shaped, the present invention is not limited to this. The first and second cover regions only need to be disposed so as to span at least the boundaries between the side margin portions and the external layer portions. In order to further enhance the moisture resistance reliability, however, the first and second cover regions are preferably disposed so as to span the boundaries between the side margin portions and the internal layer portion as well, and it is more preferable that each has a loop shape.
Although the multilayer ceramic capacitor 1 in the above-described example embodiments includes a dielectric ceramic, the present invention is not limited to this. For example, the multilayer ceramic capacitor may include a piezoelectric ceramic, a semiconductor ceramic, or a magnetic ceramic. When including a piezoelectric ceramic, the multilayer ceramic capacitor functions as a piezoelectric component. The piezoelectric ceramic may be, for example, a PZT-based ceramic. When including a semiconductor ceramic, the multilayer ceramic capacitor functions as a thermistor. The semiconductor ceramic may be, for example, a spinel-based ceramic. When including a magnetic ceramic, the multilayer ceramic capacitor functions as an inductor. The magnetic ceramic may be, for example, ferrite.

Although descriptions have been given of example embodiments and variations of the present invention, the present invention is not limited to these example embodiments and variations.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including an internal layer portion in which a plurality of dielectric layers and a plurality of internal electrode layers are stacked in an alternating pattern, one pair of main surfaces opposed to each other in a lamination direction, one pair of end surfaces opposed to each other in a lengthwise direction orthogonal to the lamination direction, and one pair of side surfaces opposed to each other in a width direction orthogonal to both the lamination direction and the lengthwise direction; and
one pair of external electrodes located on the respective end surfaces and connected to the internal electrode layers;
wherein the multilayer body includes one pair of side margin portions on both sides of the internal layer portion in the width direction, and one pair of external layer portions on both sides of the internal layer portion in the lamination direction so as to be positioned between the side margin portions;
the one pair of side surfaces includes a first side surface and a second side surface;
the one pair of side margin portions includes a first side margin portion on the first side surface and a second side margin portion on the second side surface;
the multilayer ceramic capacitor further comprises:
a first cover region including an inorganic material and positioned on outer surfaces of the multilayer body so as to span boundaries between the first side margin portion and the respective external layer portions; and
a second cover region including the inorganic material and positioned on outer surfaces of the multilayer body so as to span boundaries between the second side margin portion and the respective external layer portions; and
the end surfaces each include an uncovered section not covered with either the first cover region or the second cover region, and connected to the external electrodes at the uncovered sections.

2. The multilayer ceramic capacitor according to claim 1, wherein the inorganic material includes at least one of Si, Ti, Ba, or Zr.

3. The multilayer ceramic capacitor according to claim 1, wherein
the first cover region has a loop shape surrounding an area in at least the lengthwise direction; and
the second cover region has a loop shape surrounding an area in at least the lengthwise direction.

4. The multilayer ceramic capacitor according to claim 1, wherein
a thickness of the first cover region is about 1 μm or greater and not greater than about 10 μm; and
a thickness of the second cover region is about 1 μm or greater and not greater than about 10 μm.

5. The multilayer ceramic capacitor according to claim 1, wherein
the multilayer ceramic capacitor has a substantially cuboid shape;
a dimension of the first cover region in the width direction is about 10% or greater of a dimension of the multilayer body in the width direction and not greater than about 20% of the dimension of the multilayer body in the width direction; and
a dimension of the second cover region in the width direction is about 10% or greater of the dimension of the multilayer body in the width direction and not greater than about 20% of the dimension of the multilayer body in the width direction.

6. The multilayer ceramic capacitor according to claim 1, wherein
a dimension of the first side margin portion in the width direction is about 5 μm or greater and not greater than about 40 μm; and
a dimension of the second side margin portion in the width direction is about 5 μm or greater and not greater than about 40 μm.

7. The multilayer ceramic capacitor according to claim 1, wherein each of the side margin portions includes a plurality of layers, an inner layer that is closest to the internal layer portion among the plurality of layers and an outer layer that is farthest from the internal layer portion among the plurality of layers.

8. The multilayer ceramic capacitor according to claim 7, wherein
each of the inner layer and the outer layer includes a ceramic, dielectric ceramic particles, and an additive between the dielectric ceramic particles; and
the additive in the inner layer and in the outer layer are different from each other.

9. The multilayer ceramic capacitor according to claim 7, wherein a dimension of the outer layer in the width direction is larger than a dimension of the inner layer in the width direction.

10. The multilayer ceramic capacitor according to claim 9, wherein
the dimension of the inner layer in the width direction is about 0.1 μm or greater and not greater than about 20 μm; and
the dimension of the outer layer in the width direction is about 5 μm or greater and not greater than about 20 μm.

11. The multilayer ceramic capacitor according to claim 1, wherein a thickness of each of the internal electrode layers is about 0.8 μm or less.

12. The multilayer ceramic capacitor according to claim 7, wherein a thickness of each of the dielectric layers is about 0.55 μm or less.

13. The multilayer ceramic capacitor according to claim 7, wherein an Si content of the outer layer is higher than an Si content of the inner layer.

14. The multilayer ceramic capacitor according to claim 7, wherein a Ba content of the outer layer is higher than a Ba content of the inner layer.

15. The multilayer ceramic capacitor according to claim 7, wherein the outer layer has fewer voids than the inner layer.

16. The multilayer ceramic capacitor according to claim 7, wherein the plurality of layers include differing amounts of resin.

17. The multilayer ceramic capacitor according to claim 7, wherein the inner layer has a different amount of additive than the outer layer.

18. The multilayer ceramic capacitor according to claim 7, wherein a dimension of the inner layer in the width direction is larger than a dimension of the outer layer in the width direction.

19. The multilayer ceramic capacitor according to claim 1, wherein the plurality of internal electrodes includes floating internal electrode layers.

20. The multilayer ceramic capacitor according to claim 1, wherein the multilayer body includes a plurality of capacitor components between opposed ones of the plurality of internal electrodes and connected in series.
